(19) United States
(12) Patent Application Publication
(10) Pub. No.: US 2026/0003124 A1
(43) Pub. Date: Jan. 1, 2026

(54) MULTIWAVELENGTH OPTICAL SWITCHING

(71) Applicant: Lightmatter, Inc., Boston, MA (US)

(72) Inventor: Alexander Sludds, Cambridge, MA (US)

(73) Assignee: Lightmatter, Inc., Boston, MA (US)

(21) Appl. No.: 19/255,025

(22) Filed: Jun. 30, 2025

Related U.S. Application Data
(60) Provisional application No. 63/666,503, filed on Jul. 1, 2024.

(51) Int. Cl. G02B 6/293; G02B 6/35

(52) U.S. Cl. CPC G02B 6/29343; G02B 6/29341; G02B 6/29382; G02B 6/3536

(57) ABSTRACT

Described herein are optical switches that enable high-speed, low-loss, and low-crosstalk switching across multiple wavelengths within a CMOS-compatible platform. The optical switches described herein use resonant devices (e.g., microring resonators) controlled via carrier-induced phase modulation effects. To allow for multi-wavelength operation, the inventor proposes matching the free spectral range (FSR) of a resonant device to the spacing between adjacent WDM channels. By matching the FSR of a resonant device to the spacing between adjacent WDM channels, all the WDM channels can be switch simultaneously, thereby increasing the system's ability to perform parallel, high-speed switching. Resonant devices of the types described herein may be implemented in various ways. In one example, a device may be configured as a microring resonator, a closed-loop waveguide positioned adjacent to a bus waveguide, where light can couple into and out of the microring through evanescent coupling.

### CROSS-REFERENCE TO RELATED APPLICATIONS

This application claims the benefit under 35 U.S.C. § 119 (e) of U.S. Provisional Application Ser. No. 63/666,503, filed on Jul. 1, 2024, under Attorney Docket No. L0858.70091US00 and entitled “MULTIWAVELENGTH OPTICAL SWITCHING,” which is hereby incorporated herein by reference in its entirety.

### BACKGROUND

Optical switches are fundamental components in photonic integrated circuits (PICs) and optical communication systems, enabling selective routing of optical signals without converting them to electrical form. These devices operate by controlling the propagation path of light through one or more optical waveguides, typically using mechanisms that modulate the refractive index of a material or introduce constructive or destructive interference between optical paths.

### BRIEF SUMMARY

In some aspects, the techniques described herein relate to optical switches that enable high-speed, low-loss, and low-crosstalk switching across multiple wavelengths within a CMOS-compatible platform. The optical switches described herein use resonant devices (e.g., microring resonators) controlled via carrier-induced phase modulation effects. To allow for multi-wavelength operation, the inventor proposes matching the free spectral range (FSR) of a resonant device to the spacing between adjacent WDM channels. By matching the FSR of a resonant device to the spacing between adjacent WDM channels, all the WDM channels can be switch simultaneously, thereby increasing the system's ability to perform parallel, high-speed switching. Resonant devices of the types described herein may be implemented in various ways. In one example, a device may be configured as a microring resonator, a closed-loop waveguide positioned adjacent to a bus waveguide, where light can couple into and out of the microring through evanescent coupling.

In some aspects, the techniques described herein relate to a device, including an optical resonator exhibiting a free spectral range (FSR), wherein the optical resonator is configured to be in either a first state or a second state; a drop port coupled to the optical resonator; a thru port coupled to the optical resonator; and an input port coupled to the optical resonator, wherein the input port is configured to simultaneously receive a plurality of optical signals, each of the plurality of optical signals having a different carrier wavelength that aligns with the FSR of the optical resonator when in the first state.

In some aspects, the techniques described herein relate to a device, wherein the optical resonator includes a semiconductor junction, and wherein the first state results from a first bias condition of the semiconductor junction and the second state results from a second bias condition of the semiconductor junction.

In some aspects, the techniques described herein relate to a device, wherein the optical resonator includes a plurality of cascaded microring resonators.

In some aspects, the techniques described herein relate to a device, wherein a first microring resonator of the plurality of cascaded microring resonator has a different dimension than a second microring resonator of the plurality of cascaded microring resonators.

In some aspects, the techniques described herein relate to a device, wherein the optical resonator is configured to change from the first state to the second state using a Kerr effect.

In some aspects, the techniques described herein relate to a device, each of the plurality of optical signals has a different carrier wavelength that aligns with the FSR of the optical resonator when in the first state in an O-band, S-band, C-band or L-band.

In some aspects, the techniques described herein relate to a device, wherein: in the first state, the optical resonator is configured to transmit the optical signals from the input port to the drop port, and in the second state, the optical resonator is configured to transmit the optical signals from the input port to the thru port.

In some aspects, the techniques described herein relate to a device, wherein the FSR of the optical resonator when in the first state is between 200 GHz and 600 GHz.

In some aspects, the techniques described herein relate to a device, including a wavelength division multiplexing (WDM) source configured to generate light having carrier wavelengths associated with respective WDM channels, wherein first and second WDM channels that are adjacent to one another are separated from one another by a spectral spacing; and an optical resonator coupled to the WDM source, wherein the optical resonator exhibits a free spectral range (FSR) that matches the spectral spacing between the first and second WDM channels.

In some aspects, the techniques described herein relate to a device, wherein the optical resonator includes a microring resonator and a semiconductor junction embedded in the microring resonator.

In some aspects, the techniques described herein relate to a device, wherein a change in a bias condition associated with the microring resonator results in a change in the FSR of the optical resonator.

In some aspects, the techniques described herein relate to a device, wherein the change in the bias condition associated with the microring resonator results in the change in the FSR of the optical resonator through a Kerr effect.

In some aspects, the techniques described herein relate to a device, wherein the FSR is between 200 GHz and 600 GHz.

In some aspects, the techniques described herein relate to a device, further including an input port, a thru port and a drop port that are coupled to the optical resonator, wherein the WDM source is coupled to the optical resonator through the input port and wherein the input port and the thru port share a common waveguide, wherein: in a first state, the optical resonator is configured to transmit the light having the carrier wavelengths associated with respective WDM channels from the input port to the drop port, and in a second state, the optical resonator is configured to transmit the light having the carrier wavelengths associated with respective WDM channels from the input port to the thru port.

In some aspects, the techniques described herein relate to a device, wherein the optical resonator includes a semiconductor junction, and wherein the first state corresponds to a first bias condition associated with the semiconductor junction and the second state corresponds to a second bias condition associated with the semiconductor junction.

In some aspects, the techniques described herein relate to a device, wherein the optical resonator includes a plurality of cascaded microring resonators.

In some aspects, the techniques described herein relate to a method for controlling a device, including controlling an optical resonator to transmit light having carrier wavelengths associated with respective WDM channels from a first waveguide to a second waveguide, the first and second waveguides being evanescently coupled to the optical resonator, wherein first and second WDM channels that are adjacent to one another are separated from one another by a spectral spacing, wherein controlling the optical resonator includes: biasing the optical resonator to produce a free spectral range (FSR) that matches the spectral spacing between the first and second WDM channels.

In some aspects, the techniques described herein relate to a method, wherein: biasing the optical resonator includes forward-biasing or reverse-biasing a semiconductor junction embedded in the optical resonator.

In some aspects, the techniques described herein relate to a method, wherein biasing the optical resonator results in a FSR that is between 200 GHz and 600 GHz.

In some aspects, the techniques described herein relate to a method, further including controlling the optical resonator to transmit the light having the carrier wavelengths associated with respective WDM channels through the first waveguide by biasing the optical resonator so that the FSR does not match the spectral spacing between the first and second WDM channels.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in the figures in which they appear.

FIG. 1A is a schematic diagram illustrating an optical device including a microring resonator, in accordance with some embodiments.

FIG. 1B is a schematic diagram illustrating an optical device including two cascaded microring resonators, in accordance with some embodiments.

FIG. 1C is a schematic diagram illustrating an optical device including four cascaded microring resonators, in accordance with some embodiments.

FIG. 1D is a schematic diagram illustrating an optical device including two cascaded microring resonators having different dimensions, in accordance with some embodiments.

FIG. 2A is a plot illustrating the transmission spectrum of an optical device at the drop port overlaid with spectral lines representing wavelength division multiplexing (WDM) channels, in accordance with some embodiments.

FIG. 2B is a plot illustrating a portion of the plot of FIG. 2A in additional detail, in accordance with some embodiments.

FIG. 2C is a plot illustrating the spectrum of a 56G non-return to zero (NRZ) signal overlaid with the spectral response of the optical device of FIG. 1A, in accordance with some embodiments.

FIG. 3 is a schematic diagram illustrating a Benes network including multiple optical switches, in accordance with some embodiments.

### DETAILED DESCRIPTION

The inventor has recognized and appreciated the need for a low-loss, low-crosstalk, multi-wavelength optical switch capable of high-speed operation (e.g., with switching times on the order of approximately 1 ns to 4 ns, or more generally less than 10-20 ns) using materials and processes compatible with existing complementary metal-oxide-semiconductor (CMOS) photonics platforms. Such switches are essential for scalable, high-bandwidth optical interconnects and signal routing in photonic integrated circuits (PIC), where minimizing losses and crosstalk directly affects signal integrity and multi-wavelength operation enables wavelength division multiplexing (WDM) to increase data throughput.

Conventional optical switches generally require trade-offs among these key parameters. For example, thermally controlled devices typically exhibit slow switching times (e.g., approximately 10 μs). Conversely, Mach Zehnder interferometers (MZIs) that rely on carrier-induced phase modulation offer fast switching speeds but suffer from significant optical loss and crosstalk.

The inventor has developed optical switches that are not constrained by these trade-offs, enabling high-speed, low-loss, and low-crosstalk switching across multiple wavelengths within a CMOS-compatible platform. The optical switches described herein use resonant devices (e.g., microring resonators) controlled via carrier-induced phase modulation effects. Use of carrier-induced phase modulation allows these optical switches to be significantly faster than thermally controlled devices because the plasma dispersion effect (e.g., the Kerr effect)—upon which carrier-induced phase modulation relies—is a significantly faster mechanism than the thermo-optic effect. However, carrier-induced phase modulation presents a major drawback relative to thermally controlled devices—this effect is substantially weaker. To harness the fast response of carrier-induced phase modulation despite its relatively weak effect, traditional devices often employ MZIs, which offer extended optical paths that allow the phase shift to accumulate to an operable level. However, these longer interaction lengths increase optical loss and introduce greater crosstalk. To circumvent this trade-off, the inventor proposes combining the fast response of carrier-induced phase modulation with the compact nature of resonant devices. In resonant devices, the phase shift can accumulate over optical round trips within the resonator, substantially enhancing this effect compared to the single-pass configuration of MZIs.

To allow for multi-wavelength operation, the inventor proposes matching the free spectral range (FSR) of a resonant device to the spacing between adjacent WDM channels. The FSR of an optical resonant device is a quantity that represents the spectral spacing between adjacent resonance peaks. The FSR can be expressed in terms of frequency (e.g., gigahertz) or wavelength (e.g., nanometers). In a microring resonator, for example, the FSR represents the spacing between adjacent wavelengths (or frequencies) at which the device supports constructive interference. On the other hand, the spacing between adjacent WDM channels represents the spectral separation (either in terms of wavelength or frequency) between channels reserved for wavelength division multiplexing. WDM channels of the types described herein form wavelength intervals used to perform optical communication consistent with WDM techniques. Each WDM channel is characterized by a corresponding carrier wavelength. A carrier wavelength of a WDM channel may be the wavelength positioned in the middle of the wavelength interval of a WDM channel. Alternatively or additionally, a carrier wavelength of a WDM channel may be the wavelength that exhibits the absolute peak intensity within the wavelength interval of a WDM channel. Alternatively or additionally, a carrier wavelength of a WDM channel may be the nominal wavelength of emission of an optical source. The wavelength of emission may be “nominal” in that the optical source may emit a finite spectrum of wavelengths around the nominal wavelength due to spectral broadening effects. Light having a carrier wavelength associated with a WDM channel is referred to herein as an “optical signal.”

The inventor has recognized and appreciated that by matching the FSR of a resonant device to the spacing between adjacent WDM channels, all the WDM channels can be switched simultaneously, thereby increasing the system's ability to perform parallel, high-speed switching.

The inventor has further recognized and appreciated that fast optical devices of the types described herein may be employed not only as high-speed switches, but also as high-speed shutters or high-speed attenuators. When operated as a shutter, the device may be used to quickly enable or disable the transmission of light from an optical WDM source. When operated as an attenuator, the device may be used to modulate optical power levels. In either case, the device enables simultaneous control of optical intensity across all WDM channels. Accordingly, some embodiments implement the optical devices described herein as broadband shutters or broadband attenuators.

When operated as an attenuator, a resonant device may attenuate light as it travels from an input port to a thru port to about 10% (corresponding to −10 dB leakage at the thru port), to about 1% (corresponding to −20 dB leakage at the thru port), or to about 0.1% (corresponding to −30 dB leakage at the thru port), or to any value within these values, for example. On the other hand, when operated as an attenuator, a resonant device may attenuate light as it travels from an input port to a thru port with a leakage in excess of −30 dB.

Resonant devices of the types described herein may be implemented in various ways. In one example, a device may be configured as a microring resonator, a closed-loop waveguide positioned adjacent to a bus waveguide, where light can couple into and out of the microring through evanescent coupling. In another example, the device may be implemented as a microdisk resonator, a circular dielectric disk that confines light through total internal reflection along its periphery, supporting whispering-gallery modes. In yet another example, the device may be implemented as a racetrack resonator. To enhance the sharpness of the spectral response, higher-order resonant devices (e.g., cascaded, multi-stage microrings, microdisks or racetracks) may be employed. These higher-order configurations exhibit a steeper spectral roll-off and a flatter passband, thereby improving filtering performance and reducing inter-channel crosstalk.

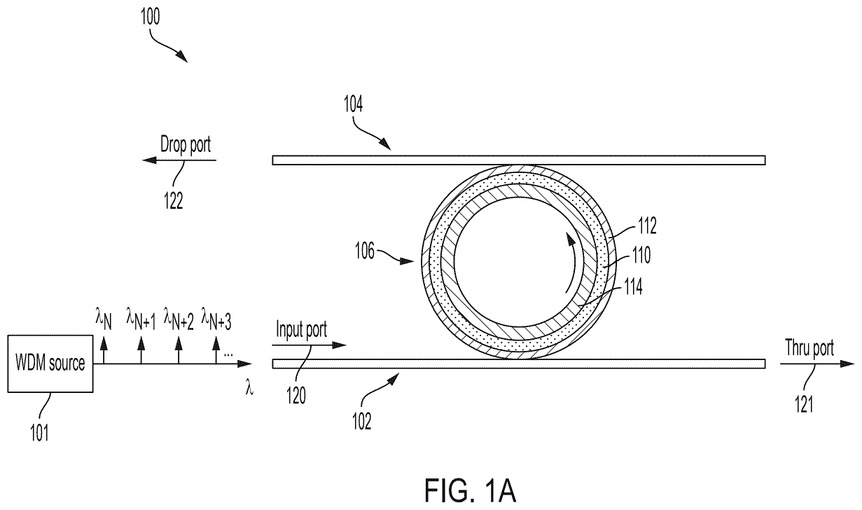

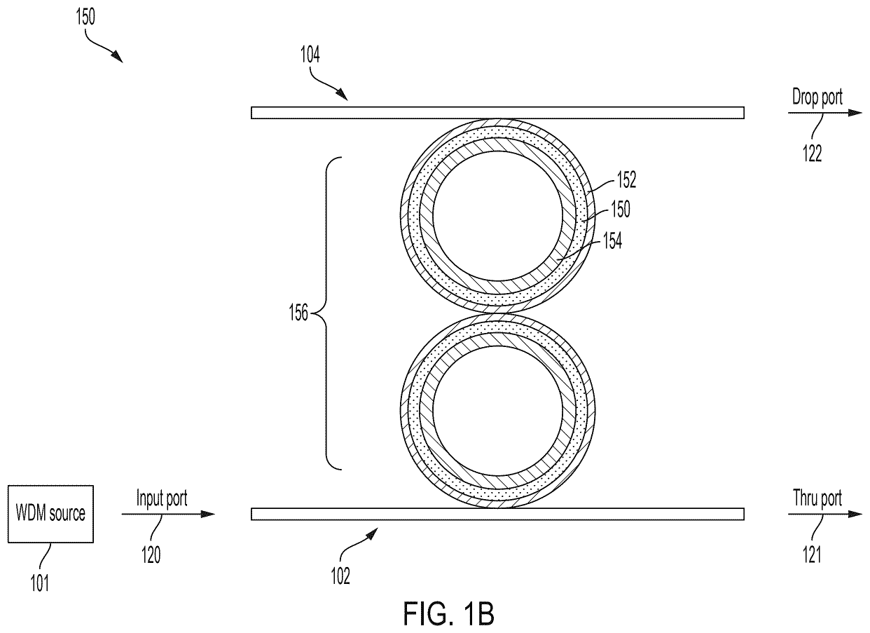

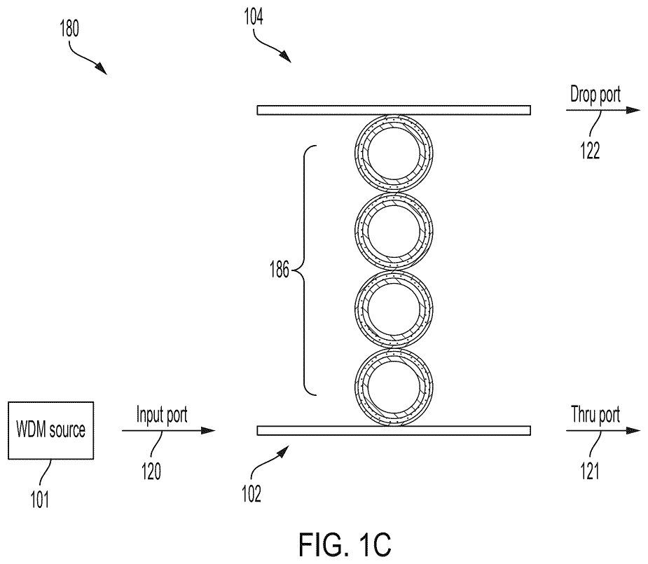

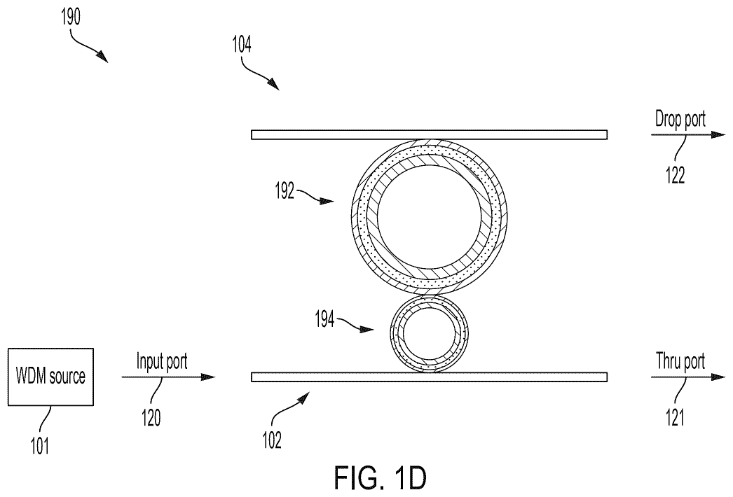

FIG. 1A is a schematic diagram illustrating an optical device including one microring resonator, in accordance with some embodiments. FIGS. 1B-1C are schematic diagrams illustrating optical devices including two cascaded microring resonators and four cascaded microring resonators, respectively. As described above, the higher-order nature of the devices of FIGS. 1B-1C can enhance the sharpness of the spectral response relative to the implementation of FIG. 1A. Lastly, the optical device of FIG. 1D may be used to provide a Vernier configuration. It should be noted that the optical devices of FIGS. 1A-1D can be used as optical switches, shutters or attenuators.

Referring first to FIG. 1A, optical device 100 includes waveguides 102 and 104 and a microring resonator 106. Microring resonator 106 is evanescently coupled to both of the waveguides. A WDM source 101 is optically coupled to waveguide 102, either directly or indirectly. In indirect coupling schemes, one or more intermediate optical components (e.g., optical modulators, amplifiers, couplers, etc.) may be interposed between WDM source 101 and waveguide 102. WDM source 101 is configured to emit multiple optical spectral lines, forming a WDM set. In FIG. 1A, λ_{N}, λ_{N+1}, λ_{N+2}, λ_{N+3}, etc. represent the carrier wavelengths of the set. The set may include any number of wavelengths. WDM source 101 may be implemented using one or more lasers. In some embodiments, the laser(s) may be implemented as distributed-feedback (DFB) laser(s) or distributed Bragg reflectors (DBR) laser(s). The laser(s) may be configured to emit in any suitable band, including in the O-band, in the S-band, in the C-band or in the L-band, for example. The nominal spectral spacing between adjacent WDM channels may be set depending on the requirements of the system connected to optical device 100. The spacing may be between 100 GHz and 800 GHz, between 100 GHz and 600 GHz, between 100 GHz and 400 GHz, between 100 GHz and 200 GHz, between 200 GHz and 800 GHz, between 200 GHz and 600 GHz, between 200 GHz and 400 GHz, between 200 GHz and 300 GHz, between 300 GHz and 800 GHz, between 300 GHz and 600 GHz, between 300 GHz and 500 GHz, between 300 GHz and 400 GHz, between 400 GHz and 800 GHz, between 400 GHz and 700 GHz, between 400 GHz and 600 GHz, between 400 GHz and 500 GHz, or in any range between those ranges. Other ranges are also possible. The spectral spacing is said to be nominal in that it is subject to temperature fluctuations and fabrication tolerances.

Waveguide 102 defines an input port 120 and a thru port 121, disposed on opposite sides of the waveguide relative to the location where waveguide 102 couples to microring resonator 106. Waveguide 104 defines a drop port 122. Light travels through drop port 122 in the opposite direction relative to the direction of propagation through input port 120. This is because propagation within microring resonator 106 occurs in the counterclockwise direction (in optical devices including even number of resonant devices, light travels through drop port 122 in the same direction relative to the direction of propagation through input port 120). In this arrangement, only spectral lines that are aligned with a resonant mode of microring resonator 106 couple to drop port 122. Light associated with wavelengths that are not aligned with resonant modes exits optical device 100 via thru port 121.

Microring resonator 106 is tunable; as such, its spectral response can be electrically adjusted. The tunability of microring resonator 106 is based on carrier-induced phase modulation, a phenomenon by which a variation in the local concentration of carriers (electron or holes) produces a change in local refractive index—and a result, it produces an optical phase shift when light travels through it. A variation in the local concentration of carriers can take the form of carrier injection (whereby the carrier concentration is increased) or carrier depletion (whereby the carrier concentration is reduced). Either mechanism leads to a phase shift, though in the opposite direction. Carrier injection or depletion can be achieved by embedding a semiconductor junction in the waveguide that defines microring resonator 106. In the example of FIG. 1A, a PIN junction is embedded in microring resonator 106. Region 110 is intrinsic (undoped) whereas regions 112 114 are N-doped and P-doped, respectively (although the opposite arrangement is also possible). Regions 112, 110 and 14 may be concentric and may be arranged so that region 112 is disposed inside region 110 and region 110 is disposed inside region 114. Carrier injection is achieved by direct-biasing the PIN junction. By contrast, carrier depletion is achieved by reverse-biasing the PIN junction. The profile of the waveguide is designed to confine the optical mode primarily in the intrinsic region 110. As a result, light experiences low optical loss as it travels along the microring.

Carrier injection exhibits a time constant of hundreds of picoseconds, resulting in a rapid change in refractive index and absorption coefficient. This rapid change results in a shift in the device's resonant response. In re-aligning the device's resonant wavelengths to the WDM channels, the actuation speed is limited by the carrier recombination time of silicon (a few nanoseconds). In some embodiments, the switching time can be further reduced by making use of equalization techniques (e.g., feed-forward equalization) to enable a switching time limited by carrier sweepout (e.g., similar to photodetectors).

Optical device 100 exhibits a FSR that is given by the following expression:

$$FSR = \frac{{n}_{eff} L}{m ( m + 1 )}$$

where n_{eff} is the effective refractive index, L is the round-trip optical path length, and m is the resonant mode order. For small changes in m, the FSR can be approximated as:

$$FSR ∼ \frac{{λ}^{2}}{{n}_{g} L}$$

where λ is the wavelength and n_{g} is the group index. Optical device 100 may be designed to achieve a n_{g}×L product that produces an FSR that matches the WDM channel spacing. In some embodiments, the FSR (expressed in terms of frequency) of optical device 100 may be less than 800 GHz, less than 700 GHz, less than 600 GHz, less than 500 GHz, less than 400 GHz, less than 300 GHz, less than 200 GHz or less than 100 GHz. For example, the FSR may be between 100 GHz and 800 GHz, between 100 GHz and 600 GHz, between 100 GHz and 400 GHz, between 100 GHz and 200 GHz, between 200 GHz and 800 GHz, between 200 GHz and 600 GHz, between 200 GHz and 400 GHz, between 200 GHz and 300 GHz, between 300 GHz and 800 GHz, between 300 GHz and 600 GHz, between 300 GHz and 500 GHz, between 300 GHz and 400 GHz, between 400 GHz and 800 GHz, between 400 GHz and 700 GHz, between 400 GHz and 600 GHz, between 400 GHz and 500 GHz, or in any range between those ranges. Other ranges are also possible.

Optical device 150 (FIG. 1B) is similar to optical device 100, but it replaces microring resonator 106 with a set of two cascaded microring resonators 156. Local heaters may be used to tune the spectral responses of the microring resonators relative to each other using the thermo-optic effect. If the microring resonators are properly tuned relative to each other, they exhibit a steeper roll-off and a flatter response relative to the single-resonator implementation of FIG. 1A. Given the even number of resonators, light travels through drop port 122 in the same direction as the direction of propagation through input port 120. Optical device 180 (FIG. 1C) is also similar to optical device 100, but it replaces microring resonator 106 with a set of four cascaded microring resonators 186. Given the increased number of resonator, the response of optical device 180 (if properly tuned) can be even steeper and flatter than that of optical device 150.

Optical device 190 (FIG. 1D) is similar to optical device 150 in that it includes two microring resonators. Unlike the resonators of FIG. 1B, however, microring resonators 192 and 194 have different diameters. Using microring resonators of different dimensions can result in a Vernier configuration, in which the combined response of the system produces constructive interference only at wavelengths where the resonance conditions of both resonators align. A Vernier configuration can be used to perform odd-even channel filtering by exploiting the mismatch in FSRs of two microring resonators. As such, only alternating WDM channels (e.g., corresponding to either odd or even indices) are dropped, depending on the relative alignment of resonances.

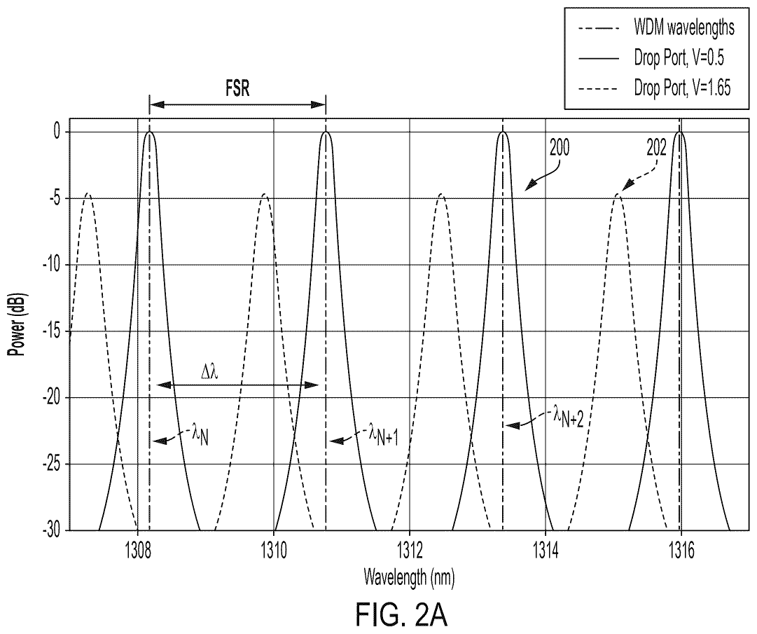

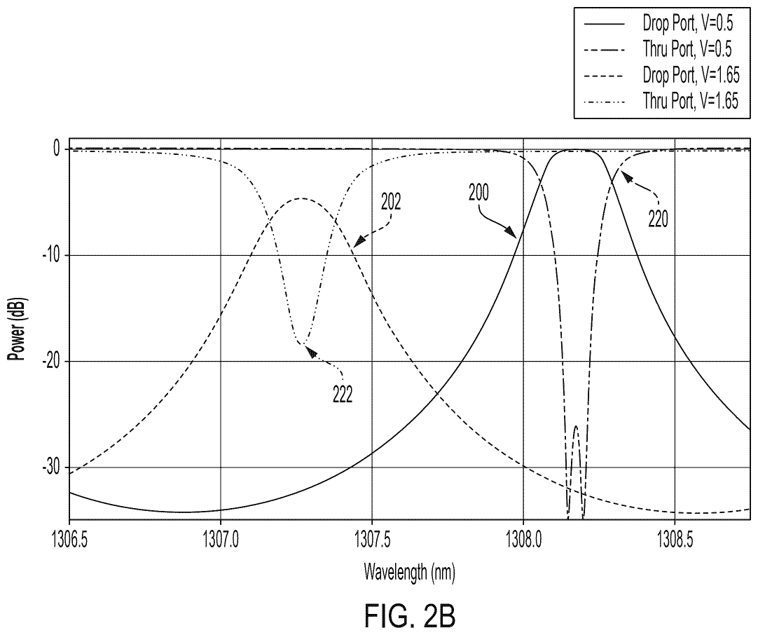

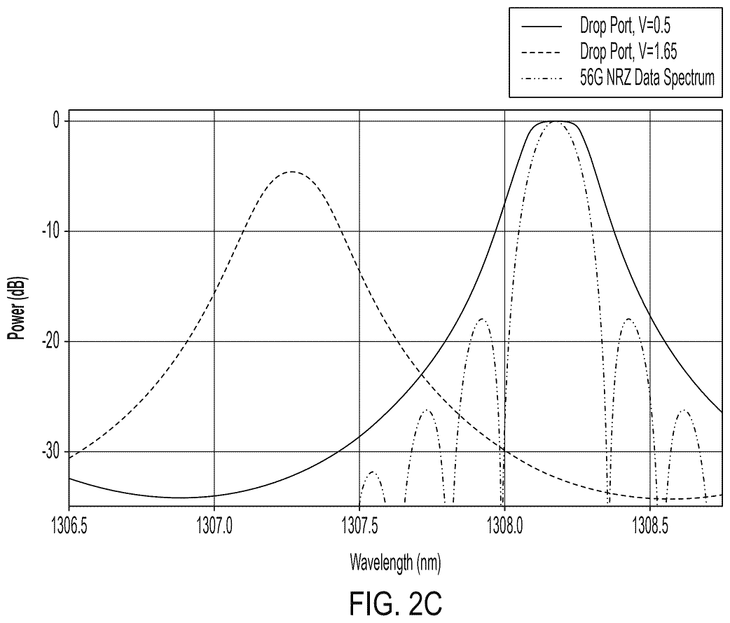

To illustrate how a resonant optical device may be designed to match the FSR with the spacing between adjacent WDM, reference is made to FIGS. 2A-2C. FIG. 2A is a plot illustrating the transmission spectrum of an optical switch at the drop port overlaid with spectral lines representing wavelength division multiplexing (WDM) channels, in accordance with some embodiments. In FIG. 2A, the x-axis represents a wavelength axis while the y-axis represents a power axis. Wavelengths are expressed in nanometers while power is expressed in dB. The spectral lines labeled λ_{N}, λ_{N+1}, λ_{N+2}, etc. represent the spectrum of light emitted by WDM source 101. Each spectral line λᵢ represents the carrier wavelength of a WDM channel. The quantity Δλ represents the spacing between adjacent carrier wavelengths. In the example of FIG. 2A, Δλ is approximately equal to 2.75 nm (corresponding to about 480 GHz at 1310 nm).

Curves 200 and 202 represent the fraction of the power traveling through input port 120 that exits the optical switch through drop port 122. As can be appreciated from FIG. 2A, curves 200 and 202 have a Lorentzian profile, corresponding to a first-order resonator (e.g., the microring resonator of FIG. 1A). When higher-order resonators are used (e.g., as shown in FIGS. 1B-1C), the profiles of curves 200 and 202 have sharper roll-offs and flatter tops. Curves 200 and 202 are obtained under different bias conditions, resulting in different states of the resonant device. In the first state (corresponding to the bias condition of curve 200), a voltage of 0.5 V is applied to the PIN junction formed by regions 112, 110 and 114; in the bias condition corresponding to curve 202, a voltage of 1.65 V is applied to the PIN junction. As can be appreciated from FIG. 2A, under the first bias condition (V=0.5 V), the FSR of the microring resonator matches Δλ and the spectral lines are aligned with the peaks of curve 200. The result is that all the carrier wavelengths emitted by WDM source 101 are simultaneously transferred to drop port 122. In the second state (corresponding to the bias condition of curve 202), the insertion loss is less than 0.1 dB per WDM channel. As the voltage bias is increased from 0.5 V to 1.65 V, the spectral response of the microring resonator undergoes a blue shift (it shifts towards smaller wavelengths). As a result, the spectral lines associated with the WDM channels are misaligned relative to the peaks of curve 202.

An optical device may leverage the behavior described in connection with FIG. 2A to operate as a broadband switch. In one bias condition (e.g., V=0.5 V), the switch transfers all the WDM wavelengths to the drop port. In another bias condition (e.g., V=1.65 V), the switch transfers all the WDM wavelengths to the thru port. Alternatively, an optical device may leverage the behavior described in connection with FIG. 2A to operate as a broadband shutter or attenuator. To operate as a shutter, a voltage bias in excess of 1.65 V may be applied, leading to an insertion loss greater than 30 dB. To operate as an attenuator, a voltage bias between 0.5 V and 1.65 V may be applied, leading to an insertion loss between 0.1 dB and 30 dB.

FIG. 2B is a plot illustrating a portion of the plot of FIG. 2A in additional detail, in accordance with some embodiments. Specifically, the plot of FIG. 2B depicts the resonance corresponding to 1308.2 nm (at V=0.5 V) and 1307.3 nm (at V=1.65 V). In addition to the spectral responses at the drop port (curves 200 and 202), FIG. 2B illustrates the spectral responses at the thru port. Curve 220 represents the spectral response at the thru port at V=0.5 V; curve 222 represents the spectral response at the thru port at V=1.65 V. FIG. 2B illustrates that as the voltage bias is increased from 0.5 V to 1.65 V, the response undergoes a blue shift.

FIG. 2C is a plot illustrating the spectrum of a 56G non-return to zero (NRZ) signal overlaid with the spectral response of the optical device of FIG. 1A, in accordance with some embodiments. The purpose of FIG. 2C is to illustrate that the spectral response associated with this resonant order is sufficiently broad to accommodate a 56G NRZ signal without causing significant distortion.

The inventor has further recognized and appreciated that fast optical switches of the types described herein may be connected together to create a reconfigurable Benes network. A Benes network is a type of reconfigurable multi-stage interconnection network in which any input can be connected to any output. Benes networks are typically implemented using recursive architectures in which 2×2 switches are arranged in multiple stages. Such a network may be used for implementing various optical communication protocols using WDM.

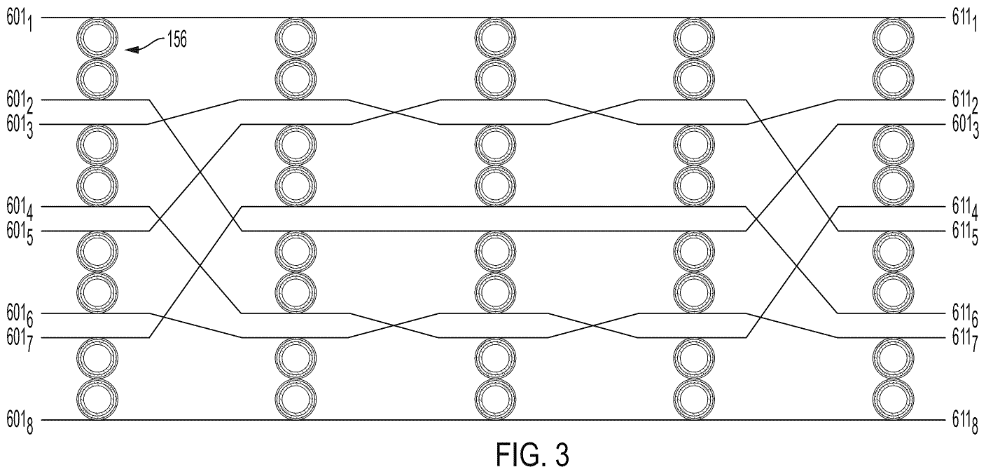

FIG. 3 is a schematic diagram illustrating a Benes network including multiple optical switches, in accordance with some embodiments. The Benes network of FIG. 3 includes eight inputs (601₁, 601₂, 601₃, 601₄, 601₅, 601₆, 601₇ and 601₈), eight outputs (611₁, 611₂, 611₃, 611₄, 611₅, 611₆, 611₇ and 611₈) and twenty switches. In this example, the switches are implemented using a set of two cascaded microring resonators 156, an example of which is shown in FIG. 1B. However, other devices of the types described herein may be used. Benes networks in accordance with other embodiments may include different numbers of input, outputs and/or switches. For example, a network may include 64 inputs, 64 outputs and 11 stages, where each stage includes 32 resonant devices. The inputs and outputs of FIG. 3 may include waveguides. These waveguides are controllably coupled to one another in various ways using the resonant devices acting as switches. As such, any signal entering any particular input port may be controlled to exit any of the eight output ports. In some embodiments, the input signals include WDM signals where the multiple wavelengths are selected to align with the FSR of the resonant devices of the network.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than described, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

What is claimed is:

1. A device, comprising:
an optical resonator exhibiting a free spectral range (FSR), wherein the optical resonator is configured to be in either a first state or a second state;
a drop port coupled to the optical resonator;
a thru port coupled to the optical resonator; and
an input port coupled to the optical resonator, wherein the input port is configured to simultaneously receive a plurality of optical signals, each of the plurality of optical signals having a different carrier wavelength that aligns with the FSR of the optical resonator when in the first state.

2. The device of claim 1, wherein the optical resonator comprises a semiconductor junction, and wherein the first state results from a first bias condition associated with the semiconductor junction and the second state results from a second bias condition associated with the semiconductor junction.

3. The device of claim 1, wherein the optical resonator comprises a plurality of cascaded microring resonators.

4. The device of claim 3, wherein a first microring resonator of the plurality of cascaded microring resonator has a different dimension than a second microring resonator of the plurality of cascaded microring resonators.

5. The device of claim 1, wherein the optical resonator is configured to switch from the first state to the second state using a Kerr effect.

6. The device of claim 1, each of the plurality of optical signals has a different carrier wavelength that aligns with the FSR of the optical resonator when in the first state in an O-band, S-band, C-band or L-band.

7. The device of claim 1, wherein:
in the first state, the optical resonator is configured to transmit the optical signals from the input port to the drop port, and
in the second state, the optical resonator is configured to transmit the optical signals from the input port to the thru port.

8. The device of claim 1, wherein the FSR of the optical resonator when in the first state is between 200 GHz and 600 GHz.

9. A device, comprising:
a wavelength division multiplexing (WDM) source configured to generate light having carrier wavelengths associated with respective WDM channels, wherein first and second WDM channels that are adjacent to one another are separated from one another by a spectral spacing; and
an optical resonator coupled to the WDM source, wherein the optical resonator exhibits a free spectral range (FSR) that matches the spectral spacing between the first and second WDM channels.

10. The device of claim 9, wherein the optical resonator comprises a microring resonator and a semiconductor junction embedded in the microring resonator.

11. The device of claim 10, wherein a change in a bias condition associated with the semiconductor junction results in a change in the FSR of the optical resonator.

12. The device of claim 11, wherein the change in the bias condition associated with the semiconductor junction results in the change in the FSR of the optical resonator through a Kerr effect.

13. The device of claim 9, wherein the FSR is between 200 GHz and 600 GHz.

14. The device of claim 9, further comprising an input port, a thru port and a drop port, wherein the WDM source is coupled to the optical resonator through the input port and wherein the input port and the thru port share a common waveguide, wherein:
in a first state, the optical resonator is configured to transmit the light having the carrier wavelengths associated with respective WDM channels from the input port to the drop port, and
in a second state, the optical resonator is configured to transmit the light having the carrier wavelengths associated with respective WDM channels from the input port to the thru port.

15. The device of claim 14, wherein the optical resonator comprises a semiconductor junction, and wherein the first state corresponds to a first bias condition associated with the semiconductor junction and the second state corresponds to a second bias condition associated with the semiconductor junction.

16. The device of claim 9, wherein the optical resonator comprises a plurality of cascaded microring resonators.

17. A method for controlling a device, comprising:
controlling an optical resonator to transmit light having carrier wavelengths associated with respective WDM channels from a first waveguide to a second waveguide, the first and second waveguides being evanescently coupled to the optical resonator, wherein first and second WDM channels that are adjacent to one another are separated from one another by a spectral spacing, wherein controlling the optical resonator comprises:
biasing the optical resonator to produce a free spectral range (FSR) that matches the spectral spacing between the first and second WDM channels.

18. The method of claim 17, wherein:
biasing the optical resonator comprises forward-biasing or reverse-biasing a semiconductor junction embedded in the optical resonator.

19. The method of claim 17, wherein biasing the optical resonator results in an FSR that is between 200 GHz and 600 GHz.

20. The method of claim 17, further comprising:
controlling the optical resonator to transmit the light having the carrier wavelengths associated with respective WDM channels through the first waveguide by biasing the optical resonator so that the FSR does not match the spectral spacing between the first and second WDM channels.
